(19) United States
(12) Patent Application Publication
(10) Pub. No.: US 2013/0325571 A1
(43) Pub. Date: Dec. 5, 2013

(54) System and method for providing travel directions

(71) Applicants: Alan Vincent Green, Penrith (AU); Michael Steven Perrow, Pyrmont (AU)

(72) Inventors: Alan Vincent Green, Penrith (AU); Michael Steven Perrow, Pyrmont (AU)

(73) Assignee: GOOGLE INC., Mountain View, CA (US)

(21) Appl. No.: 13/482,284

(22) Filed: May 29, 2012

(51) Int. Cl. G06Q 30/02; G01C 21/00; G06Q 30/06

(52) U.S. Cl. 705/14.15; 705/26.1

(57) ABSTRACT

A computer-implemented method for providing travel directions includes receiving a request for a travel route from a first location to a second location; determining the travel route; providing, based on the travel route, a suggested transaction and directions for a first portion of the travel route; and receiving a notification that the suggested transaction has occurred. A computer-readable medium comprising computer-executable instructions that perform the method is also provided. In response to a notification that the suggested transaction has occurred, directions for a second portion of the travel route may be provided.

### BACKGROUND

There are many websites that provide route directions to travelers. These websites may provide directions for traveling by car, on foot, by public transit, or by some combination thereof. For example, various websites allow travelers to provide a starting location and a destination, and in response provides turn-by-turn directions to the destination, as well as a map showing the travel route. Travelers having a device, such as a smart phone, capable of determining the user's location may be able to request directions from their current location to the destination. As another example, dedicated GPS devices are available that include preloaded maps for use in vehicles, and provide driving directions to travelers.

GPS directions may be monetized in a number of ways. For example, maps may be preloaded on a navigation unit, and their cost is incorporated into the price of the unit. Updated or upgraded maps may be offered at an additional cost, and may be loaded in the navigation unit. In another example, directions may be commercially provided in a service model, wherein directions are provided for a recurring subscription fee.

### SUMMARY

While travelers could, in theory, be charged individually on a per-trip basis for directions, there is currently no cost-effective model for doing so. The amount travelers are willing to pay for directions for a single trip is somewhat small, such that transaction costs would reduce or eliminate any financial gain for the provider of the navigation services.

It would be beneficial to provide travelers with directions from a first location to a second location by providing directions to a suggested transaction. The cost of the directions could recovered as part of the suggested transaction, or through advertising costs paid by a sponsor of the suggested transaction. According to one aspect, directions to the second location are provided responsive to receiving a notification that the suggested transaction has occurred.

According to one aspect, a computer-implemented method for providing travel directions is provided. The method includes receiving a request for a travel route from a first location to a second location; determining the travel route; providing, based on the travel route, a suggested transaction and directions for a first portion of the travel route; and receiving a notification that the suggested transaction has occurred.

According to an embodiment, the method further includes providing, responsive to the notification that the suggested transaction has occurred, directions for a second portion of the travel route. According to a further embodiment, the second portion of the travel route corresponds to the route from a location associated with the suggested transaction to the second location. In one embodiment, the suggested transaction is located proximal to the second location.

According to an embodiment, the method further includes storing, responsive to the notification that the suggested transaction has occurred, a credit redeemable for receiving directions.

According to another aspect, a system for providing travel directions is provided. A request processor is configured to receive a request for a travel route from a first location to a second location. A route processor is configured to determine the travel route. A transaction processor is configured to provide, based on the travel route, a suggested transaction and directions for a first portion of the travel route. A notification processor is configured to receive a notification that the suggested transaction has occurred.

According to an embodiment, the transaction processor is further configured to provide, responsive to the notification that the suggested transaction has occurred, directions for a second portion of the travel route. In some embodiments, the second portion of the travel route corresponds to the route from a location associated with the suggested transaction to the second location.

### BRIEF DESCRIPTION OF THE FIGURES

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 shows a first interface according to an embodiment;

FIG. 2 depicts a second interface according to an embodiment;

FIG. 3 illustrates a third interface according to an embodiment;

FIG. 4 shows a fourth interface according to an embodiment;

FIG. 5 depicts a flow chart of a method for providing travel directions according to an embodiment;

FIG. 6 illustrates an example system for providing travel directions according to an embodiment;

FIGS. 7A and 7B show an example implementation according to an embodiment; and

FIG. 8 depicts an example system upon which various aspects of the present embodiments may be implemented.

### DETAILED DESCRIPTION

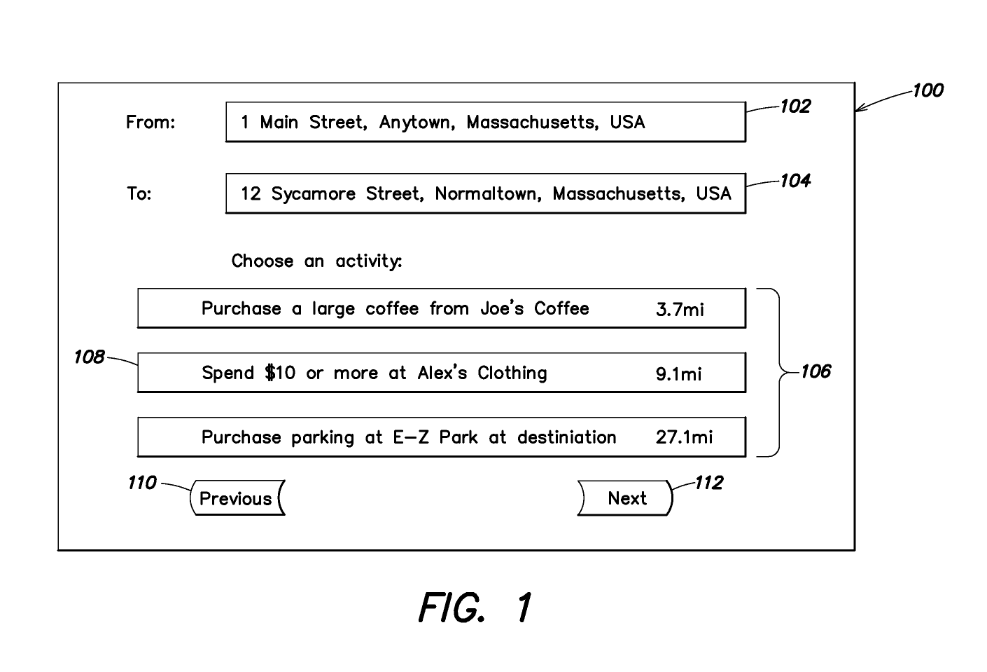

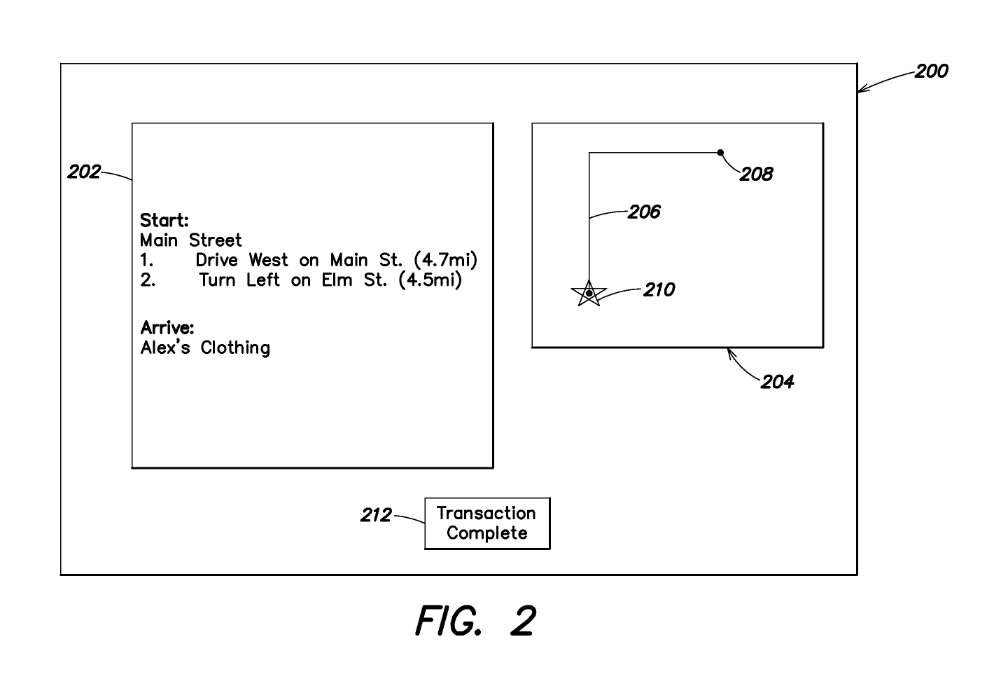

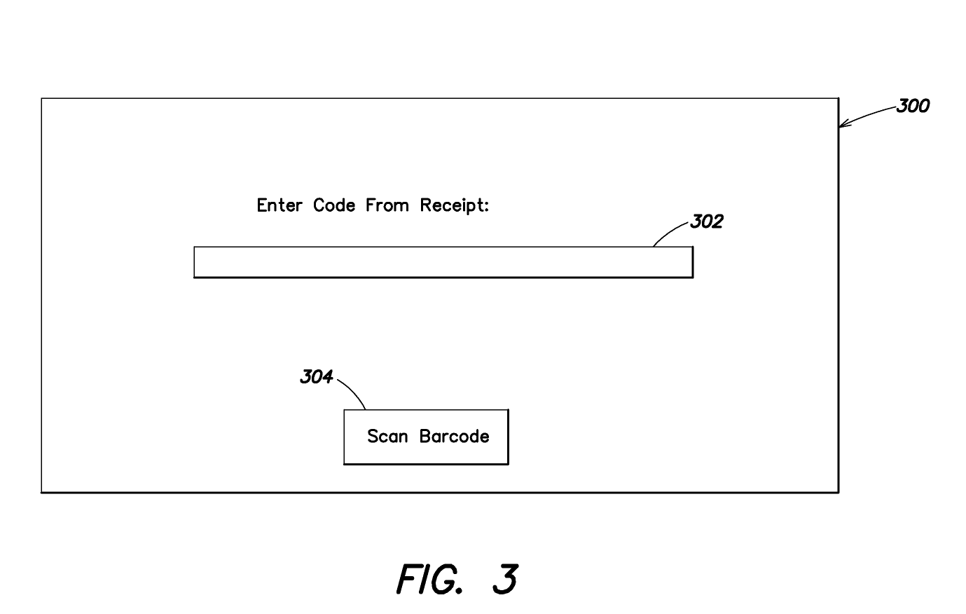

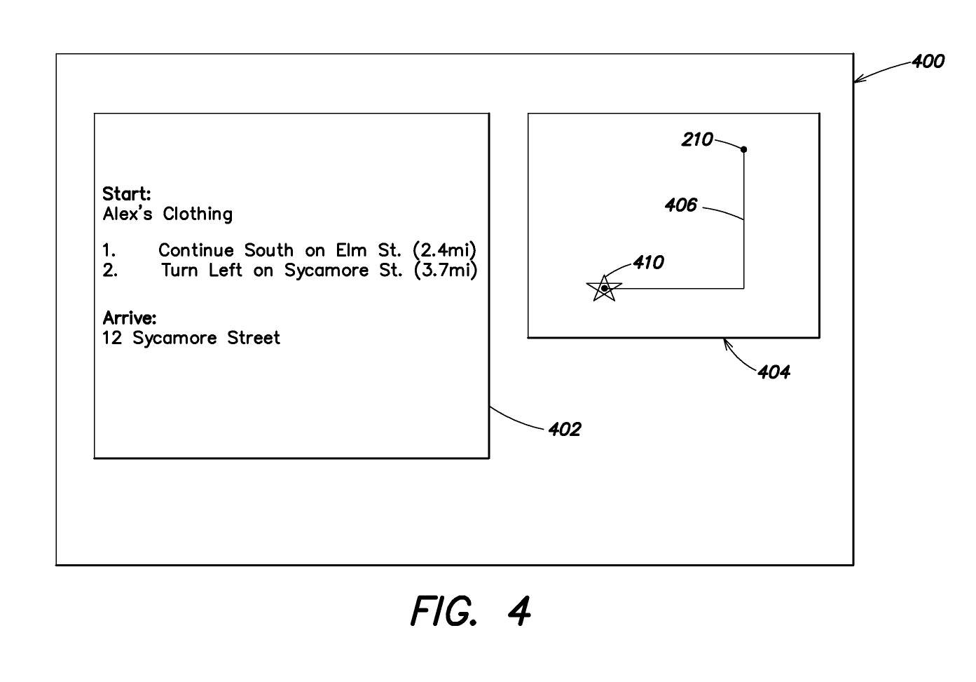

As discussed above, there is a need for an application that provides travel directions by providing a traveler with directions to a suggested transaction and receiving notification that the suggested transaction has occurred. FIG. 1 shows a first interface 100 including a first location bar 102 and a second location bar 104. According to one feature, the first location bar 102 displays a first location representing the traveler's starting location address. The starting location address may be determined from user input, previously stored in a memory, or may be the user's current location as determined by the navigation unit. According to one embodiment, the second location bar 104 displays a second location representing the traveler's destination address, which may be determined from user input or may be previously stored in a memory.

According to one embodiment, a travel route is determined based on the first location and the second location, and one or more suggested transactions 106 are displayed. Suggested transactions 106 may be displayed to the traveler as options that can be selected by the traveler within an interface of a device that provides direction. The suggested transactions 106 are real-world or online transactions that may be conducted along or nearby the travel route. A database of available transactions may be maintained by the provider of navigation services. Suggested transactions 106 may be identified from the universe of available transactions according to, for example, identified preferences of the traveler, proximity to the travel route, an amount paid by a sponsor of an available transaction, or some combination of factors.

According to one aspect, exemplary suggested transactions 106 are shown. For example, one suggested transaction 106 requires the traveler to purchase a large coffee from Joe's Coffee, an establishment 3.7 miles away on the travel route. Another suggested transaction 106 requires the traveler to purchase $10 or more worth of goods at Alex's Clothing, located 9.1 miles away. Yet another suggested transaction 106 allows the traveler to purchase parking at an E-Z Park facility near the destination, 27.1 miles away.

According to one aspect, the suggested transaction 106 is an online transaction. It may be possible to perform the online transaction in any location, or it may be a requirement that the online transaction be performed near the first location, near the second location, or along or near the travel route. The traveler's location may be determined by the device on which the directions are being accessed or viewed, for example using GPS or techniques to determine the device's location. In one example, the suggested transaction may be an online purchase of a coffee from Joe's Coffee within a certain proximity of the establishment; the traveler could then display an indication of the purchase to a cashier to redeem the purchase, and an indication that the suggested transaction had occurred could be transmitted. In a further example, the suggested transaction may be an online purchase of an audio book along the travel route.

According to one embodiment, the traveler can choose to view additional suggested transactions, and navigate among pages of suggested transactions. For instance, the traveler may navigate additional suggested transactions by selecting page icons 110 and 112.

In one example, the traveler selects a selected transaction 108 by indicating, through the first interface 100, which of the suggested transactions the traveler intends to complete. Information identifying a selected transaction may be stored in a memory of the device. Such information may be used by a processor to determine directions from the first location to a location of the selected transaction. Further, a processor may determine directions from the selected location to another selected location, the second location, or other location.

According to one aspect, directions to the selected transaction 108 from the first location are shown on a second interface 200. The directions include textual direction 202 as well as a map 204 showing the travel route 206 from the first location 208 to the suggested transaction location 210. According to one embodiment, turn-by-turn directions are provided, updated, and, if necessary, revised according to the traveler's current location.

According to one feature, the traveler, upon reaching the location of the suggested transaction and completing the transaction, may indicate that the transaction is complete, for example, by clicking a notification button 212. To continue a previous example, the traveler may have arrived at Alex's Clothing and spent more than $10.

After the traveler has indicated that the transaction is complete, the traveler may be prompted to confirm the transaction. According to one embodiment, a third interface 300 is shown to the traveler, who may confirm the transaction by providing an identifier. In some embodiments, the identifier may be provided by typing or otherwise entering a code into a code bar 302. The code may be printed on a receipt from the transaction, or may otherwise be provided to the traveler at the point-of-sale or through an electronic transmission. In some embodiments, the traveler may optically scan a barcode of a product or a code printed on the receipt. For example, the third interface 300 may allow the user to select a scan button 304 that activates a camera on a cell phone or other device. The code may be a bar code, QR code, or other machine-readable optical code. Non-optical techniques may be used to relay the code to a mobile device as well.

An indication that the suggested transaction has been completed may then be transmitted to the provider of the navigation services. In response, according to one embodiment, a fourth interface 400 displays directions from the location of the selected transaction to the second location. The directions include textual directions 402 and/or a map 404 showing the travel route 406 from the suggested transaction location 210 to the second location 410. According to one embodiment, turn-by-turn directions may be provided, updated and, if necessary, revised according to the traveler's current location.

According to an embodiment, the traveler may opt to forego receiving directions from the location of the selected transaction to the second location, and may instead be given credit toward future directions. The credit may be redeemable by the traveler in the future to receive directions from the first location to the second location, or between any other points, such as a third location and a fourth location, without the need to complete a suggested transaction along the way. Credit may be associated with the traveler and stored in a database to be accessed and redeemed later. The amount of credit give to a traveler engaging in a suggested transaction may vary based on the distance covered by the directions or the value of the suggested transaction. The amount of credit associated with a suggested transaction may alternatively correspond to a number of future trips. For example, the credit earned from a suggested transaction may be redeemable for any single trip of any length or duration in the future.

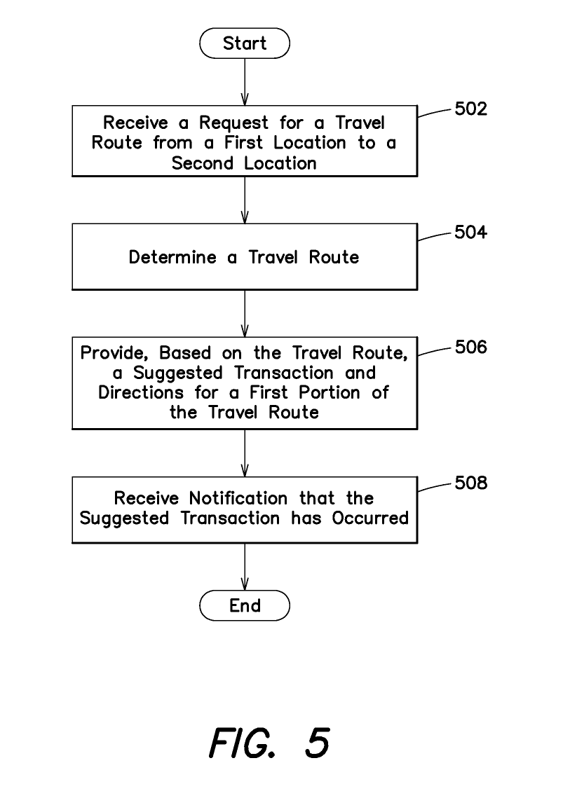

FIG. 5 shows a flowchart of a method 500 for providing travel directions according to an embodiment of the invention. At step 502, a request is received for a travel route from a first location to a second location. At step 504, a travel route is determined. For example, a computer system or navigation device may incorporate a processor that performs an algorithm for determining a route between the first location and the second location. The algorithm may calculate a route that is optimal in some way, such the shortest length or the shortest travel time. The system may take into account additional parameters, such as the traveler's wish to avoid highways. At step 506, a suggested transaction and directions for a first portion of the travel route are provided based on the travel route. According to some embodiments, the first portion of the travel route corresponds to the route from the first location to the suggested transaction. The suggested transaction may be located proximal to the travel route, to the first location, or to the second location. At step 508, notification is received that the suggested transaction has occurred.

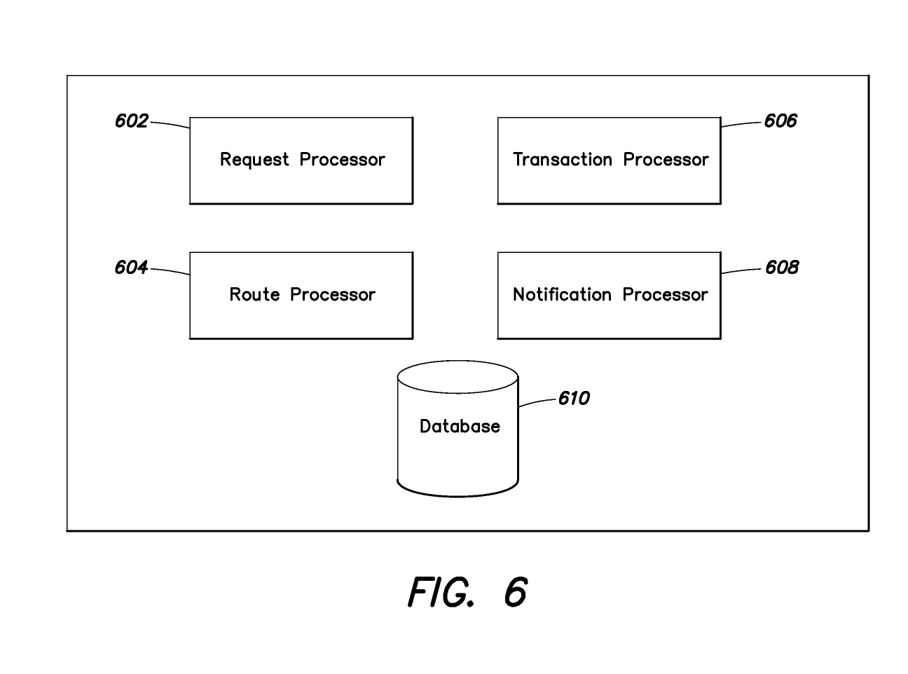

FIG. 6 shows an example block diagram of a system configured to perform the described embodiments.

A request processor 602 is configured to receive a request for a travel route from a first location to a second location. The request may be received from the traveler through a user interface. For example, the traveler may type a first address associated with the first location, and a second address associated with the second location. The traveler may also be presented with a list of previously-selected locations from which to select the first location and the second location. In some embodiments, the traveler may select the current location as the first location and/or the second location. The current location may be determined with a GPS unit or other component capable of determining the current location.

A route processor 604 is configured to determine the travel route. The travel route may be determined by finding the An optimal travel route may be determined, for example, one with the shortest length or the shortest travel time. The route processor 604 may take into account additional parameters, such as the traveler's wish to avoid highways.

A transaction processor 606 is configured to provide, based on the travel route, a suggested transaction and directions for a first portion of the travel route.

A notification processor 608 is configured to receive a notification that the suggested transaction has occurred. In some embodiments, the notification may be provided by the traveler, who may type or otherwise enter a code into a user interface. The code may be printed on a receipt from the transaction, or may otherwise be provided to the traveler at the point-of-sale or through an electronic transmission. In some embodiments, the traveler may optically scan a barcode, QR code, or other machine-readable optical code of a product or a code printed on the receipt, or may use a non-optical input method supported by his or her mobile device to obtain a code from the merchant or an actual product. In other embodiments, the notification may be provided by a merchant who is a party to the transaction. In still other embodiments, the notification may be provided by a third party, such as a payment processor.

In some embodiments, two or more of the request processor 602, the route processor 604, the transaction processor 606, and the notification processor 608 may be embodied on the same processor, and may include software components performed on a general purpose computer.

A database 610 is configured to store available transactions and associated information, such as the location of the available transaction. The database 610 may also be configured to store credits redeemable for future directions.

According to one embodiment, a payment is received in exchange for the directions. For example, the payment may be a first payment received from a merchant to the transaction, who has received a second payment from the traveler. As another example, the payment may be received from a non-party to the transaction, for example, the manufacturer of a product involved in the transaction.

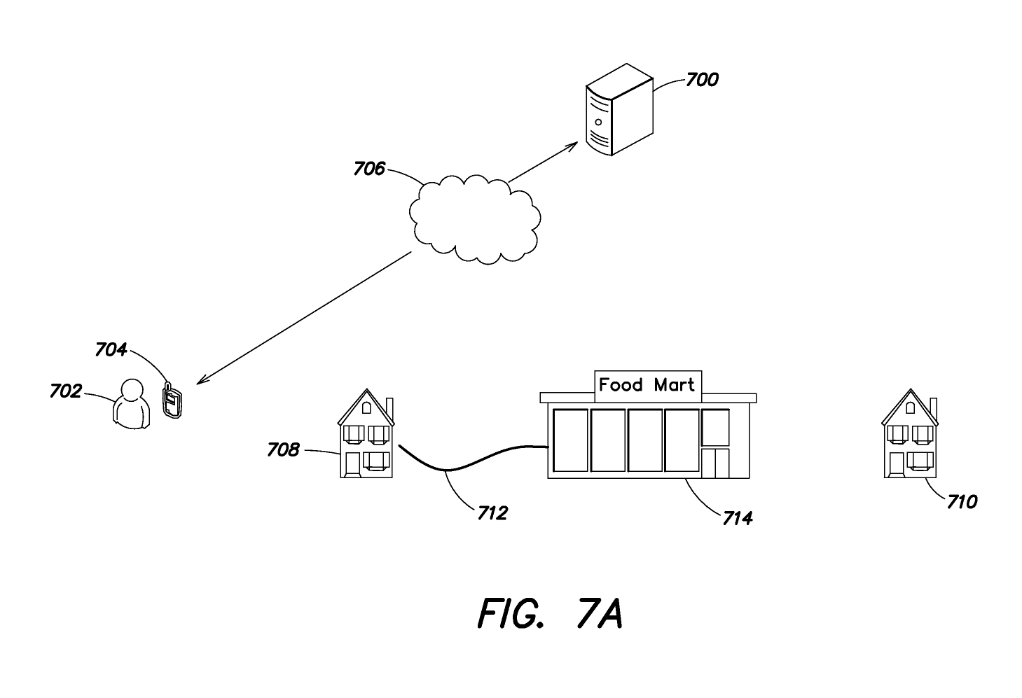

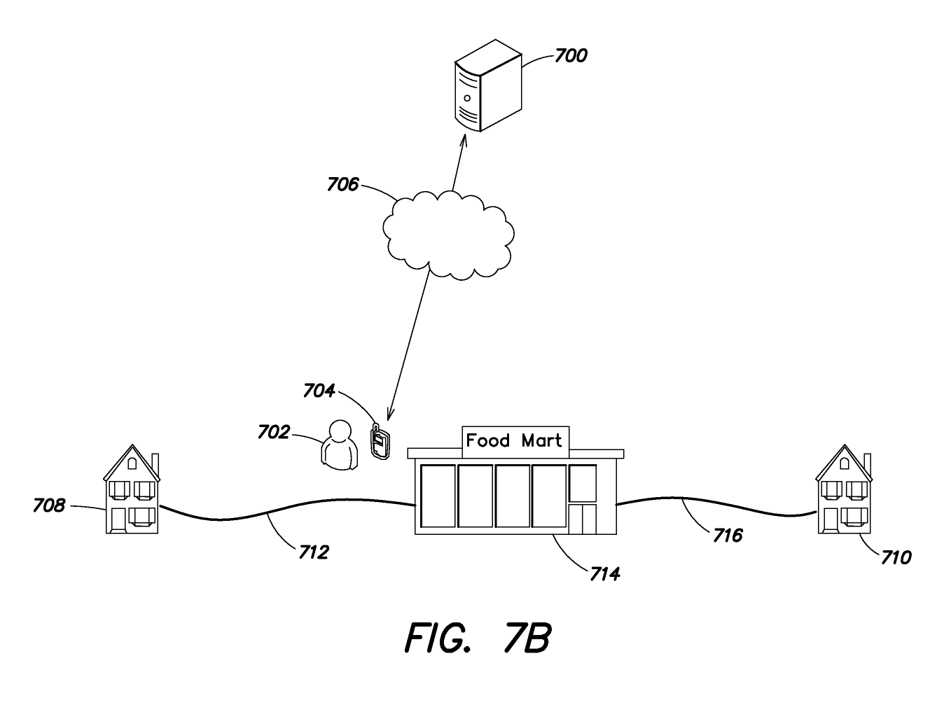

An example implementation of a system 700 configured to perform the described embodiments is shown in FIGS. 7A and 7B.

Referring first to FIG. 7A, a traveler 702 is located at a first location 708. The traveler uses a navigation device 704 to communicate, through a network 706, with the system 700. The traveler 702 may communicate a desire to receive travel directions from the first location 708 to a second location 710. In response, the system 700 provides at least one suggested transaction to be displayed on the navigation device 704. The user 702 may then select a suggested transaction. The system 700 then provides a first portion 712 of the directions, with the first portion 712 corresponding to the route from the first location 708 to the location 714 of the selected suggested transaction.

Referring now to FIG. 7B, the traveler 702 may have traveled the first portion 712 of the route, arriving at the location 714 of the selected suggested transaction. After the traveler 702 has completed the suggested transaction, the navigation device 704 may be used to transmit to the system 700 a notification that the suggested transaction is complete. The system 700 then provides a second portion 716 of the directions, with the second portion 716 corresponding to the route from the location 714 of the selected suggested transaction to the second location 710.

### Example Computer Implementations

Various aspects and functions described herein in accord with the present invention may be implemented as hardware, software, or a combination of hardware and software on one or more computer systems. There are many examples of computer systems currently in use. Some examples include, among others, network appliances, personal computers, workstations, mainframes, networked clients, servers, media servers, application servers, database servers, web servers, and virtual servers. Other examples of computer systems may include mobile computing devices, such as cellular phones, tablet computers, and personal digital assistants, and network equipment, such as load balancers, routers and switches. Additionally, aspects in accord with the present invention may be located on a single computer system or may be distributed among a plurality of computer systems connected to one or more communication networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Thus, the invention is not limited to executing on any particular system or group of systems. Further, aspects may be implemented in software, hardware or firmware, or any combination thereof. Thus, aspects in accord with the present invention may be implemented within methods, acts, systems, system placements and components using a variety of hardware and software configurations, and the invention is not limited to any particular distributed architecture, network, or communication protocol. Furthermore, aspects in accord with the present invention may be implemented as specially-programmed hardware and/or software.

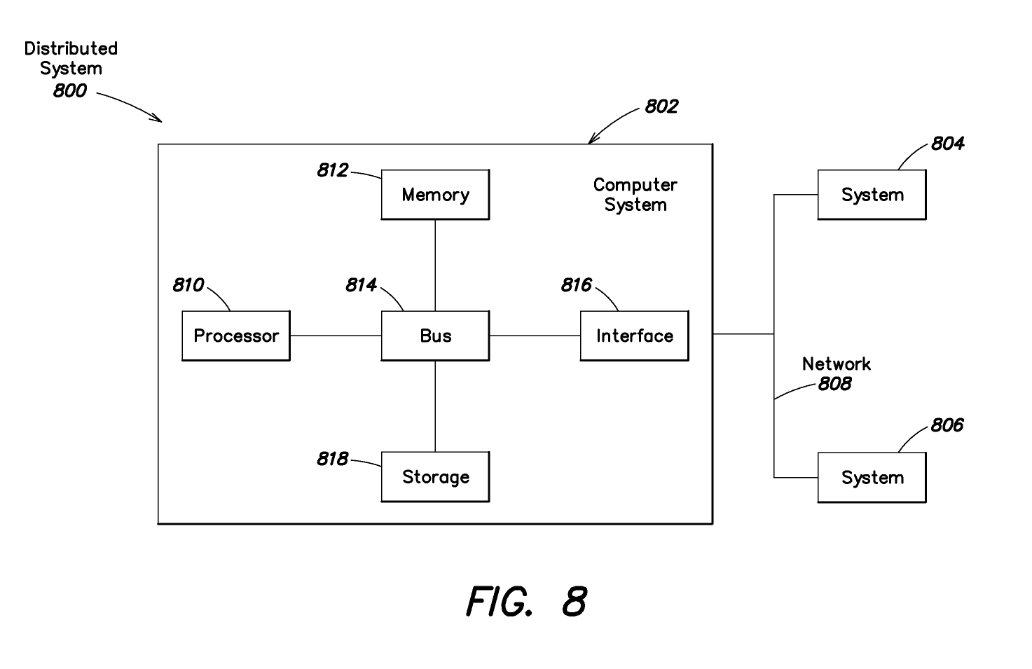

FIG. 8 shows a block diagram of a distributed computer system 800, in which various aspects and functions in accord with the present invention may be practiced. The distributed computer system 800 may include one more computer systems. For example, as illustrated, the distributed computer system 800 includes three computer systems 802, 804 and 806. As shown, the computer systems 802, 804 and 806 are interconnected by, and may exchange data through, a communication network 808. The network 808 may include any communication network through which computer systems may exchange data. To exchange data via the network 808, the computer systems 802, 804 and 806 and the network 808 may use various methods, protocols and standards including, among others, token ring, Ethernet, Wireless Ethernet, Bluetooth, TCP/IP, UDP, HTTP, FTP, SNMP, SMS, MMS, SSB, JSON, XML, REST, SOAP, CORBA IIOP, RMI, DCOM and Web Services. To ensure data transfer is secure, the computer systems 802, 804 and 806 may transmit data via the network 808 using a variety of security measures including TSL, SSL or VPN, among other security techniques. While the distributed computer system 800 illustrates three networked computer systems, the distributed computer system 800 may include any number of computer systems, networked using any medium and communication protocol.

Various aspects and functions in accord with the present invention may be implemented as specialized hardware or software executing in one or more computer systems including the computer system 802 shown in FIG. 6. As depicted, the computer system 802 includes a processor 810, a memory 812, a bus 814, an interface 816 and a storage system 818. The processor 810, which may include one or more microprocessors or other types of controllers, can perform a series of instructions that manipulate data. The processor 810 may be a well-known, commercially available processor such as an Intel Pentium, Intel Atom, ARM Processor, Motorola PowerPC, SGI MIPS, Sun UltraSPARC, or Hewlett-Packard PA-RISC processor, or may be any other type of processor or controller as many other processors and controllers are available. As shown, the processor 810 is connected to other system placements, including a memory 812, by the bus 814.

The memory 812 may be used for storing programs and data during operation of the computer system 802. Thus, the memory 812 may be a relatively high performance, volatile, random access memory such as a dynamic random access memory (DRAM) or static memory (SRAM). However, the memory 812 may include any device for storing data, such as a disk drive or other non-volatile storage device, such as flash memory or phase-change memory (PCM). Various embodiments in accord with the present invention can organize the memory 812 into particularized and, in some cases, unique structures to perform the aspects and functions disclosed herein.

Components of the computer system 802 may be coupled by an interconnection element such as the bus 814. The bus 814 may include one or more physical busses (for example, busses between components that are integrated within a same machine), and may include any communication coupling between system placements including specialized or standard computing bus technologies such as IDE, SCSI, PCI and InfiniB and. Thus, the bus 814 enables communications (for example, data and instructions) to be exchanged between system components of the computer system 802.

Computer system 802 also includes one or more interface devices 816 such as input devices, output devices and combination input/output devices. The interface devices 816 may receive input, provide output, or both. For example, output devices may render information for external presentation. Input devices may accept information from external sources. Examples of interface devices include, among others, keyboards, mouse devices, trackballs, microphones, touch screens, printing devices, display screens, speakers, network interface cards, etc. The interface devices 816 allow the computer system 802 to exchange information and communicate with external entities, such as users and other systems.

Storage system 818 may include a computer-readable and computer-writeable nonvolatile storage medium in which instructions are stored that define a program to be executed by the processor. The storage system 818 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein. A medium that can be used with various embodiments may include, for example, optical disk, magnetic disk or flash memory, among others. In operation, the processor 810 or some other controller may cause data to be read from the nonvolatile recording medium into another memory, such as the memory 812, that allows for faster access to the information by the processor 810 than does the storage medium included in the storage system 818. The memory may be located in the storage system 818 or in the memory 812. The processor 810 may manipulate the data within the memory 812, and then copy the data to the medium associated with the storage system 818 after processing is completed. A variety of components may manage data movement between the medium and the memory 812, and the invention is not limited thereto.

Further, the invention is not limited to a particular memory system or storage system. Although the computer system 802 is shown by way of example as one type of computer system upon which various aspects and functions in accord with the present invention may be practiced, aspects of the invention are not limited to being implemented on the computer system, shown in FIG. 6. Various aspects and functions in accord with the present invention may be practiced on one or more computers having different architectures or components than that shown in FIG. 6. For instance, the computer system 802 may include specially-programmed, special-purpose hardware, such as for example, an application-specific integrated circuit (ASIC) tailored to perform a particular operation disclosed herein. Another embodiment may perform the same function using several general-purpose computing devices running MAC OS System X with Motorola PowerPC processors and several specialized computing devices running proprietary hardware and operating systems.

The computer system 802 may include an operating system that manages at least a portion of the hardware placements included in computer system 802. A processor or controller, such as processor 810, may execute an operating system which may be, among others, a Windows-based operating system (for example, Windows NT, Windows 2000/ME, Windows XP, Windows 8, or Windows Vista) available from the Microsoft Corporation, a MAC OS System X operating system available from Apple Computer, one of many Linux-based operating system distributions (for example, the Enterprise Linux operating system available from Red Hat Inc.), a Solaris operating system available from Sun Microsystems, or a UNIX operating systems available from various sources. Many other operating systems may be used, and embodiments are not limited to any particular operating system.

The processor and operating system together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, functions in accord with aspects of the present invention may be implemented using an object-oriented programming language, such as SmallTalk, JAVA, C++, Ada, or C# (C-Sharp). Other object-oriented programming languages may also be used. Alternatively, procedural, scripting, or logical programming languages may be used.

Additionally, various functions in accord with aspects of the present invention may be implemented in a non-programmed environment (for example, documents created in HTML, XML or other format that, when viewed in a window of a browser program, render aspects of a graphical-user interface or perform other functions). Further, various embodiments in accord with aspects of the present invention may be implemented as programmed or non-programmed placements, or any combination thereof. For example, a web page may be implemented using HTML while a data object called from within the web page may be written in C++. Thus, the invention is not limited to a specific programming language and any suitable programming language could also be used.

In addition, the method described herein may be incorporated into other hardware and/or software products, such as a website, a mobile device, or a navigation unit.

Examples above discussed using GPS and/or other techniques to determine a device location. If location data is to be used, it can be used only after a user has provided permission after receiving information on how the location data is collected, used and handled. The location data can be used and handled in a way that respects user privacy—for example, location data may not be retained except to the extent it is needed to suggest activities and/or provide directions and any location data (or information that can be used to derive location history).

While any such data is retained, it can be stored in a controlled matter to preclude release or unauthorized access/use of the data.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A computer-implemented method for providing travel directions, comprising acts of:
receiving a request for a travel route from a first location to a second location;
determining the travel route;
providing, based on the travel route, a suggested transaction and directions for a first portion of the travel route; and
receiving a notification that the suggested transaction has occurred.

2. The computer-implemented method of claim 1, further comprising an act of providing, responsive to the notification that the suggested transaction has occurred, directions for a second portion of the travel route.

3. The computer-implemented method of claim 2, wherein the second portion of the travel route corresponds to the route from a location associated with the suggested transaction to the second location.

4. The computer-implemented method of claim 2, wherein the suggested transaction is located proximal to the second location.

5. The computer-implemented method of claim 1, further comprising an act of storing, responsive to the notification that the suggested transaction has occurred, a credit redeemable for receiving directions.

6. The computer-implemented method of claim 1, further comprising an act of receiving a first payment from a party receiving a second payment in the transaction.

7. The computer-implemented method of claim 1, further comprising an act of receiving a payment from a non-party to the transaction.

8. The computer-implemented method of claim 1, wherein the first portion of the travel route corresponds to the route from the first location to a location associated with the suggested transaction.

9. The computer-implemented method of claim 1, wherein the suggested transaction is located proximal to the travel route.

10. The computer-implemented method of claim 1, wherein the suggested transaction is located proximal to the first location.

11. The computer-implemented method of claim 1, further comprising acts of:
providing a plurality of suggested transactions; and
receiving a user selection of at least one of the plurality of suggested transactions.

12. The computer-implemented method of claim 11, wherein the suggested transaction is associated with an advertiser, further comprising an act of receiving a bid from an advertiser.

13. The computer-implemented method of claim 1, wherein the notification that the suggested transaction has occurred comprises an identifier provided by a party to the transaction.

14. The computer-implemented method of claim 13, wherein the act of receiving the notification that the suggested transaction has occurred comprises an act of receiving a notification from a merchant.

15. The computer-implemented method of claim 1, wherein the suggested transaction involves a product, and wherein the notification that the suggested transaction has occurred is determined responsive to an input of an identifier that is associated with the product.

16. A system for providing travel directions, comprising:
a request processor configured to receive a request for a travel route from a first location to a second location;
a route processor configured to determine the travel route;
a transaction processor configured to provide, based on the travel route, a suggested transaction and directions for a first portion of the travel route; and
a notification processor configured to receive a notification that the suggested transaction has occurred.

17. The system of claim 16, wherein the transaction processor is further configured to provide, responsive to the notification that the suggested transaction has occurred, directions for a second portion of the travel route.

18. The system of claim 17, wherein the second portion of the travel route corresponds to the route from a location associated with the suggested transaction to the second location.

19. The system of claim 17, wherein the suggested transaction is located proximal to the second location.

20. A computer-readable medium comprising computer-executable instructions that, when executed on a processor of a server, perform a method for providing travel directions, comprising acts of:
receiving a request for a travel route from a first location to a second location;
determining the travel route;
providing, based on the travel route, a suggested transaction and directions for a first portion of the travel route; and
receiving a notification that the suggested transaction has occurred.
